(19) United States
(12) Patent Application Publication
(10) Pub. No.: US 2025/0343226 A1
(43) Pub. Date: Nov. 6, 2025

(54) DOUBLE-COATED ELECTRODE FOR DUAL-CHEMISTRY CATHODE SYSTEM

(71) Applicant: GM GLOBAL TECHNOLOGY OPERATIONS LLC, DETROIT, MI (US)

(72) Inventors: Jung Hwi Cho, Madison Heights, MI (US); Nathaniel Hardin, Farmington Hills, MI (US); Anne M. Dailly, West Bloomfield, MI (US)

(21) Appl. No.: 18/654,081

(22) Filed: May 3, 2024

(51) Int. Cl. H01M 4/36; B60L 50/64; H01M 4/02; H01M 4/04; H01M 4/131; H01M 4/136; H01M 4/1391; H01M 4/1397; H01M 4/505; H01M 4/525; H01M 4/58

(52) U.S. Cl. CPC H01M 4/366; B60L 50/64; H01M 4/0404; H01M 4/131; H01M 4/136; H01M 4/1391; H01M 4/1397; H01M 4/505; H01M 4/525; H01M 4/5825; H01M 2004/021; H01M 2004/028; H01M 2220/20

(57) ABSTRACT

Aspects of the disclosure include a double-coated electrode for dual-chemistry cathode systems and methods of manufacturing the same. An exemplary vehicle includes an electric motor and a battery pack electrically coupled to the electric motor. The battery pack includes a battery cell that includes an anode current collector, an anode active material layer in direct contact with a surface of the anode current collector, a cathode current collector, and a cathode active material layer in direct contact with a surface of the cathode current collector. The cathode active material layer includes a dual-chemistry electrode having a first cathode layer in direct contact with the cathode current collector and a second cathode layer positioned directly on the first cathode layer. The first cathode layer and the second cathode layer are made of materials having at least one of a different particle size distribution and a different chemical makeup.

### INTRODUCTION

The present disclosure relates to battery cell manufacturing, and particularly to a double-coated electrode for dual-chemistry cathode systems.

Electrodes are widely used in a range of devices that store electrical energy, including primary (non-rechargeable) battery cells, secondary (rechargeable) battery cells, fuel cells, and capacitors. An ideal electrode needs to balance various electrical energy storage characteristics, such as, for example, energy density, power density, maximum charging rate, internal leakage current, equivalent series resistance (ESR), charge-discharge cycle durability, high electrical conductivity, and low tortuosity. Electrodes often incorporate current collectors to supplement or otherwise improve upon these electrical energy storage characteristics. Current collectors can be added to provide a higher specific conductance and can increase the available contact area to minimize the interfacial contact resistance between the electrode and its terminal.

A current collector is typically a sheet of conductive material to which the active electrode material is attached. Aluminum foil, stainless steel, copper, and titanium foil are commonly used as the current collector of an electrode. In some electrode fabrication processes, for example, a film that includes activated carbon powder (i.e., the active electrode material) is attached to a thin aluminum foil using binding material or using an adhesive layer. To improve the quality of the interfacial bond between the film of active electrode material and the current collector, the combination of the film and the current collector is processed in a pressure laminator, for example, a calendering process or roll pressing. This process is generally known as calendering. Thus, the fabrication of an electrode typically involves the production of an active electrode material film (including, e.g., cathode and/or anode slurry preparation, the incorporation of any conductive additives and binding materials, the deposition of the slurry at a defined loading amount, and drying) and the lamination of that film onto a current collector.

### SUMMARY

In one exemplary embodiment a vehicle includes an electric motor and a battery pack electrically coupled to the electric motor. The battery pack includes a battery cell that includes an anode current collector, an anode active material layer in direct contact with a surface of the anode current collector, a cathode current collector, and a cathode active material layer in direct contact with a surface of the cathode current collector. The cathode active material layer includes a dual-chemistry electrode having a first cathode layer in direct contact with the cathode current collector and a second cathode layer positioned directly on the first cathode layer. The first cathode layer and the second cathode layer are made of materials having at least one of a different particle size distribution and a different chemical makeup.

In addition to one or more of the features described herein, in some embodiments, the first cathode layer includes a material having a first particle size distribution and the second cathode layer includes a material having a second particle size distribution different than the first particle size distribution.

In some embodiments, the second particle size distribution is smaller than the first particle size distribution.

In some embodiments, the first cathode layer includes a bi-modal particle size distribution with a first set of particles having a diameter ranging between 0.1 and 7.0 microns with a D50 value of between 1.0 and 5.0 microns and a second set of particles having a diameter ranging between 5.0 and 30.0 microns with a D50 value of between 5.0 and 15.0 microns. In some embodiments, the second cathode layer includes a single-modal particle size distribution with particles having a diameter ranging between 0.01 and 200.0 microns with a D50 value of between 0.05 and 100.0 microns.

In some embodiments, the first cathode layer includes at least one of a layered oxide structure, a spinel oxide structure, a two-phase structure, and a non-olivine type structure and the second cathode layer includes an olivine structure.

In some embodiments, the first cathode layer includes at least one of nickel cobalt manganese aluminum oxide (NCMA), nickel manganese cobalt oxide (NMC), nickel cobalt aluminum oxide (NCA), lithium manganese oxide (LMO), lithium nickel manganese oxide (LNMO), lithium manganese rich (LMR) and the second cathode layer includes at least one of lithium iron phosphate (LFP) and lithium manganese iron phosphate (LMFP).

In some embodiments, the first cathode layer includes NMC and the second cathode layer includes LFP.

In another exemplary embodiment a battery cell includes an anode current collector, an anode active material layer in direct contact with a surface of the anode current collector, a cathode current collector, and a cathode active material layer in direct contact with a surface of the cathode current collector. The cathode active material layer includes a dual-chemistry electrode having a first cathode layer in direct contact with the cathode current collector and a second cathode layer positioned directly on the first cathode layer. The first cathode layer and the second cathode layer are made of materials having at least one of a different particle size distribution and a different chemical makeup.

In some embodiments, the first cathode layer includes a material having a first particle size distribution and the second cathode layer includes a material having a second particle size distribution different than the first particle size distribution.

In some embodiments, the second particle size distribution is smaller than the first particle size distribution.

In some embodiments, the first cathode layer includes a bi-modal particle size distribution with a first set of particles having a diameter ranging between 0.1 and 7.0 microns with a D50 value of between 1.0 and 5.0 microns and a second set of particles having a diameter ranging between 5.0 and 30.0 microns with a D50 value of between 5.0 and 15.0 microns. In some embodiments, the second cathode layer includes a single-modal particle size distribution with particles having a diameter ranging between 0.01 and 200.0 microns with a D50 value of between 0.05 and 100.0 microns.

In some embodiments, the first cathode layer includes at least one of a layered oxide structure, a spinel oxide structure, a two-phase structure, and a non-olivine type structure and the second cathode layer includes an olivine structure.

In some embodiments, the first cathode layer includes at least one of nickel cobalt manganese aluminum oxide (NCMA), nickel manganese cobalt oxide (NMC), nickel cobalt aluminum oxide (NCA), lithium manganese oxide (LMO), lithium nickel manganese oxide (LNMO), lithium manganese rich (LMR) and the second cathode layer includes at least one of lithium iron phosphate (LFP) and lithium manganese iron phosphate (LMFP).

In some embodiments, the first cathode layer includes NMC and the second cathode layer includes LFP.

In yet another exemplary embodiment a method can include forming a battery cell by providing an anode current collector, forming an anode active material layer in direct contact with a surface of the anode current collector, providing a cathode current collector, and forming a cathode active material layer in direct contact with a surface of the cathode current collector. The cathode active material layer includes a dual-chemistry electrode having a first cathode layer in direct contact with the cathode current collector and a second cathode layer positioned directly on the first cathode layer. The first cathode layer and the second cathode layer are made of materials having at least one of a different particle size distribution and a different chemical makeup.

In some embodiments, the first cathode layer includes a material having a first particle size distribution and the second cathode layer includes a material having a second particle size distribution different than the first particle size distribution.

In some embodiments, the second particle size distribution is smaller than the first particle size distribution.

In some embodiments, the first cathode layer includes a bi-modal particle size distribution with a first set of particles having a diameter ranging between 0.1 and 7.0 microns with a D50 value of between 1.0 and 5.0 microns and a second set of particles having a diameter ranging between 5.0 and 30.0 microns with a D50 value of between 5.0 and 15.0 microns. In some embodiments, the second cathode layer includes a single-modal particle size distribution with particles having a diameter ranging between 0.01 and 200.0 microns with a D50 value of between 0.05 and 100.0 microns.

In some embodiments, the first cathode layer includes at least one of a layered oxide structure, a spinel oxide structure, a two-phase structure, and a non-olivine type structure and the second cathode layer includes an olivine structure.

In some embodiments, the first cathode layer includes at least one of nickel cobalt manganese aluminum oxide (NCMA), nickel manganese cobalt oxide (NMC), nickel cobalt aluminum oxide (NCA), lithium manganese oxide (LMO), lithium nickel manganese oxide (LNMO), lithium manganese rich (LMR) and the second cathode layer includes at least one of lithium iron phosphate (LFP) and lithium manganese iron phosphate (LMFP).

In some embodiments, the first cathode layer includes NMC and the second cathode layer includes LFP.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2A is an example battery cell in accordance with one or more embodiments;

FIG. 2B is a detailed view of the battery cell shown in FIG. 2A in accordance with one or more embodiments;

FIG. 3 is a cross-sectional view of a dual-chemistry cathode of the electrode stack shown in FIG. 2B in accordance with one or more embodiments; and

FIG. 4 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Electrodes often incorporate current collectors to supplement or otherwise improve upon the electrical energy storage characteristics of a final integrated device (e.g., a battery). A current collector typically includes a sheet of conductive material (e.g., aluminum foil) to which an active electrode material is attached. An energy storage system such as a battery cell or pouch can include a number of stacked anode current collectors and cathode current collectors, an active material(s) dispersed or otherwise situated on the current collectors, and a sufficient number of separators to prevent shorts between the anode current collectors and cathode current collectors. Thus, in many electrode configurations there is a clear separation between anode and cathode, and each electrode serves a specific function, with electrons flowing from the anode to the cathode through an external circuit.

As the demand for energy storage systems offering higher energy densities, faster charging, and extended operational lifespans increases, driven in part by the proliferation of electric vehicles, significant challenges have been imposed on the materials used in battery cell components. Research and development efforts are continuously directed toward identifying novel materials and manufacturing techniques that can meet escalating demands on battery cells and other energy storage systems. For example, dual-chemistry electrodes rely on a blend or combination of two different active materials within a single battery cell or pack, with the goal of leveraging the complementary characteristics of the respective materials to achieve improved overall performance (e.g., energy density, rate performance, safety, etc.).

Challenges remain, however, in designing and manufacturing batteries with dual-chemistry electrodes. In particular, manufacturing dual-chemistry electrodes typically involves so-called powder blending, whereby different powdered active materials (e.g., lithium iron phosphate (LFP) and nickel cobalt manganese aluminum oxide (NCMA) in a dual-chemistry cathode) are physically mixed to create a homogeneous mixture prior to slurry formation. In other words, powder blending involves creating dual-chemistry anodes and/or cathodes at the powder-level. Notably, powder blending results in dual-chemistry electrodes having uniform electrode properties throughout the deposited thickness and, as such, these formulations are natively single-component electrode architectures (that is, effectively the same as single-chemistry electrodes).

Unfortunately, this means that different slurry formulations and optimizations are required for each selected ratio of the respective active materials in the blend. In other words, slurry formulation modifications are required every time a change is made to the ratio between the different active material powders. Delamination is another challenge, especially for dual-chemistry cathodes, as some cathode active materials (notably LFP) have poor adhesion to the aluminum foils, stainless steel foils, and/or titanium foils typically used in cathodes. As a result, dual-chemistry cathodes are often limited to sub-94 percent active material concentrations and to porosities of no less than about 30 percent (with delamination typically occurring at or above 30 percent for 94 percent active material blends). These restrictions lower energy density and, ultimately, battery performance.

This disclosure introduces a double-coated electrode for dual-chemistry cathode systems and methods of manufacturing the same. Rather than relying on powder-level blending of cathode active materials, a double coating process using different cathode active materials is leveraged to create a novel blend cathode electrode stack. In other words, instead of conventional powder blending methods, our approach involves fabricating a double-coated electrode at the slurry-level. While described primarily in the context of dual-chemistry cathodes, dual-chemistry anode systems can be similarly built at the slurry-level and all such configurations are within the contemplated scope of this disclosure.

Blending two or more active materials (e.g., NCMA and LFP) as described herein enables electrode chemistries that leverage the complementary characteristics of two or more respective active materials (allowing, for example, the balancing of their respective strengths) in a similar manner as described for powder-level dual-chemistry electrodes. Notably, however, slurry-level dual-chemistry cathodes (or anodes) offer additional advantages that are simply not available using powder blending.

In particular, slurry-level dual-chemistry electrodes do not require different slurry formulations and optimizations when varying the ratio between different cathode layers—simply use the same formulations and vary the thicknesses of each layer instead. In other words, a fixed individually-optimized slurry can be created one time for each active material chemistry and a tunable ratio can be created by varying the thickness of each deposited layer. This simplifies manufacturing significantly, especially for fabrication lines having several slurry formation targets. Other advantages are possible.

For example, delamination can be curtailed by ordering the cathode (or anode) layers in the dual-chemistry cathode (or anode) stack such that the layer formed from active materials having the relatively highest interface/bonding compatibility with the chosen current collector is placed between the current collector and the other layer(s). The second layer can then be formed on the first layer (rather than directly on the current collector) with relatively relaxed interface restrictions. In short, the first layer can serve as an interface buffer for the second layer. Thus, slurry-level dual-chemistry electrodes described herein can be constructed to relatively higher combinations of active material concentration and porosity. For example, LFP-NCMA formulations having at least 94 percent LFP and a porosity of 30 percent have been found stable with no signs of delamination. Batteries made from slurry-level dual-chemistry electrodes (cathodes or anodes) at relatively higher active material concentrations and relatively lower porosities than those afforded by powder-level formulations will naturally provide relatively higher energy densities (increasing battery performance for same weight, etc.).

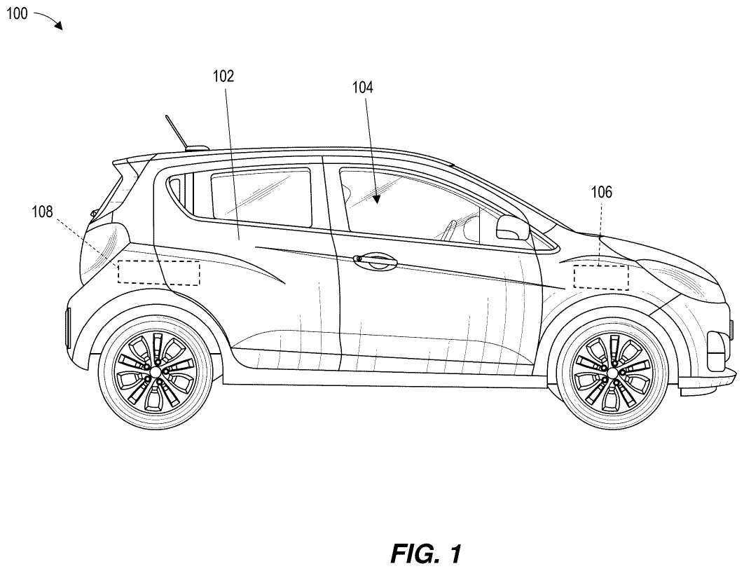

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

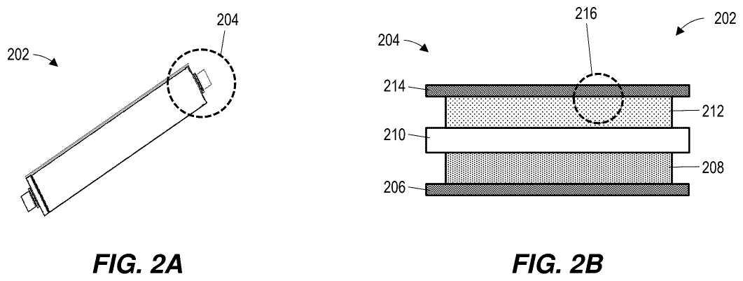

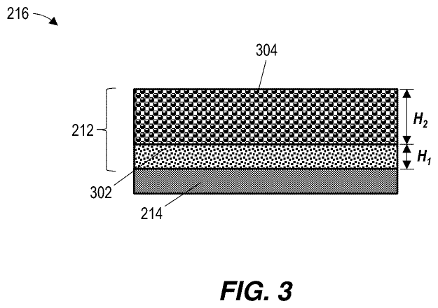

As will be detailed herein, the battery pack 108 includes one or more battery cells and/or battery pouches having a new dual-chemistry electrode design that includes slurry-level double coated electrode (cathode or anode) layers. In some embodiments, later-formed electrode layers are coated on top of prior layers. An example battery cell is shown in FIG. 2A. A detailed view of an electrode stack within the battery cell of FIG. 2A is shown in FIG. 2B. A detailed view of a dual-chemistry cathode layer of the electrode stack of FIG. 2B is shown in FIG. 3.

FIG. 2A illustrates an example battery cell 202 in accordance with one or more embodiments. The battery cell 202 can be incorporated as one of a number of battery cells in a battery pack (e.g., the battery pack 108 in FIG. 1). FIG. 2B illustrates a detailed view 204 of the battery cell 202 shown in FIG. 2A in accordance with one or more embodiments. As shown in FIG. 2B, the battery cell 202 includes, from bottom to top, an anode current collector 206, an anode active material layer 208, a separator 210, a cathode active material layer 212, and a cathode current collector 214. In some embodiments, the cathode active material layer 212 and/or the anode active material layer 208 are double-coated dual-chemistry layers. The cathode active material layer 212 and the cathode current collector 214 are discussed in greater detail with respect to FIG. 3.

The anode current collector 206 and the cathode current collector 214 can be made of sheets or foils of conductive materials. For example, the cathode current collector 214 can be made of aluminum foil, stainless steel, and/or titanium foil. Other materials are possible, such as, for example, semimetals (e.g., tin, graphite) and alloys of the metals and/or semimetals thereof. In some embodiments, the cathode current collector 214 is made of aluminum foil. The anode current collector 206 can include, for example, copper foil and/or one or more graphene layers. Each layer thickness can be approximately 1 to 3 nm, although other thicknesses are within the contemplated scope of this disclosure.

The anode active material layer 208 and the cathode active material layer 212 can include various anode or cathode active materials, respectively. The anode active material layer 208 is not meant to be particularly limited, and can also include, for example, lithium metal, activated carbon powder, graphite, silicon, silicon-graphite composites, tin, tin oxide (SnO₂), lithium titanate (Li₄Ti₅O₁₂, LTO), and combinations thereof. In some embodiments, the composite anode layer 210 includes lithium metal and at least one of lithium lanthanum zirconate (Li₇La₃Zr₂O₁₂, LLZO), lithium phosphorus oxynitride (Li₃PO₄, LiPON), lithium super ionic conductor (LISICON), and lithium germanium sulfide (Li₄GeS₄, LGS).

The cathode active material layer 212 is not meant to be particularly limited, but can include, for example, nickel manganese cobalt oxide (NMC), LFP, nickel cobalt aluminum oxide (NCA), nickel cobalt manganese aluminum oxide (NCMA), lithium manganese iron phosphate (LMFP), lithium manganese rich (LMR), lithium manganese oxide (LMO), and lithium nickel manganese oxide (LNMO).

In some embodiments, such as for sodium ion battery (SIB) applications, the cathode or anode active materials can include SIB active materials, such as layered-and tunnel-structured transition metal oxides, polyanion compounds, and prussian blue analogs (PBAs), hard carbon materials, such as petroleum coke or mesocarbon microbeads (MCMB), graphite, sodium titanates, such as Na₂Ti₃O₇ and Na_{0.44}MnO₂, tin-based compounds, such as SnO₂ and SnS₂, phosphorus-based compounds, such as phosphorus-carbon composites or phosphorus-based alloys, and combinations thereof.

Depending on battery construction (e.g., conventional vs. bi-polar current collectors, etc.) the separator 210 is optional but, if included, can be positioned to isolate they anode active material layer 208 and the cathode active material layer 212. The separator 210 can include dielectric materials such as, for example, polyethylene (PE), polypropylene (PP), polyethylene terephthalate (PET), and composites thereof, although other dielectrics are within the contemplated scope of this disclosure. In some embodiments, the separator 210 may include a thermally stable coating layer to improve shrinkage behavior (e.g., a porous ceramic coating or porous ester type polymer coating including, for example, polyimide, polyamide, polyimide-polyamide (PI/PA) copolymer, etc.).

In some embodiments, such as for solid-state electrolyte formulations, the anode active material layer 208 can include a low-voltage solid-state electrolyte. As used herein, a “low-voltage” solid-state electrolyte refers to an electrolyte having a stable structure (electrochemically stable) at a voltage measured relative to a lithium electrode reference that is below 2.5 V, for example, 0.1 V to 0.8 V. Example materials for low-voltage solid-state electrolytes include LLZO, LiPON, LISICON, and LGS, although other low-voltage solid-state electrolytes are within the contemplated scope of this disclosure. In some embodiments, the content of the first low-voltage solid-state electrolyte in the anode active material layer 208 is between 10 percent and 40 percent by weight.

In some embodiments, such as for solid-state electrolyte formulations, the cathode active material layer 212 can include a high-voltage solid-state electrolyte. As used herein, a “high-voltage” solid-state electrolyte refers to an electrolyte having a stable structure (electrochemically stable) at a voltage measured relative to a lithium electrode reference that is above 3.0 V, for example, 4.0 V to 10.0 V. Example materials for high-voltage solid-state electrolytes include lithium aluminum titanium phosphate (Li_{1.3}Al_{0.3}Ti_{1.7}(PO₄)₃, LATP), lithium aluminum germanium phosphate (Li_{1.5}Al_{0.5}Ge_{1.5}(PO₄)₃, LAGP), and lithium lanthanum titanate (LiₓLa_{(2-x)/3}TiO₃, where x is 0.2 to 0.3, LLTO), although other high-voltage solid-state electrolytes are within the contemplated scope of this disclosure. In some embodiments, the content of the high-voltage solid-state electrolyte in the cathode active material layer 212 is between 10 percent and 40 percent by weight.

FIG. 3 illustrates a detailed view 216 of the cathode active material layer 212 and the cathode current collector 214 of the battery cell 202 shown in FIG. 2B in accordance with one or more embodiments. It should be understood that the detailed view 216 of the cathode active material layer 212 and the cathode current collector 214 of the battery cell 202 is provided in lieu of a similar view of the anode active material layer 208 and the anode current collector 206 for ease of discussion only. In particular, various aspects of dual-chemistry electrodes described herein with respect to the cathode current collector 214 can be applied to the anode active material layer 208 (that is, the anode active material layer 208 can also be a dual-chemistry electrode) and all such configurations are within the contemplated scope of this disclosure.

As shown in FIG. 3, in some embodiments, the cathode active material layer 212 is a dual-chemistry electrode having a first cathode layer 302 and a second cathode layer 304. In some embodiments, the first cathode layer 302 is a so-called bottom layer formed and/or deposited directly onto the cathode current collector 214. In some embodiments, the second cathode layer 304 is a so-called top layer formed and/or deposited directly onto the first cathode layer 302.

As used herein, a “dual-chemistry” cathode (or anode) refers to an electrode having two cathode (or anode) layers of differing particle size distributions and/or chemical makeup. For example, in embodiments having differing particle size distributions, the first cathode layer 302 is made of a material having a first particle size distribution, and the second cathode layer 304 is made of a material having a second particle size distribution different than the first particle size distribution. In some embodiments, the second particle size distribution is smaller than the first particle size distribution.

In some embodiments, the first cathode layer 302 has a bi-modal particle size distribution with a first set of relatively small particles having a diameter ranging between 0.1 and 7.0 microns (μm) with a D50 (median) value of between 1.0 and 5.0 microns and a second set of relatively large particles having a diameter ranging between 5.0 and 30.0 microns with a D50 value of between 5.0 and 15.0 microns. Conversely, in some embodiments, the second cathode layer 304 has a single-modal particle size distribution with particles having a diameter ranging between 0.01 and 200.0 microns with a D50 value of between 0.05 and 100.0 microns. For example, the second cathode layer 304 can have a single-modal particle size distribution with particles having a diameter ranging between 0.01 and 0.1 microns with a D50 value of between 0.05 and 0.9 microns (that is, relatively smaller than the small particles of the first cathode layer 302). In another example, the second cathode layer 304 can have a single-modal particle size distribution with particles having a diameter ranging between 0.01 and 4.9 microns with a D50 value of between 0.05 and 4.9 microns (that is, relatively smaller than the large particles of the first cathode layer 302).

In other embodiments, the first cathode layer 302 has a single-modal particle size distribution with particles having a diameter ranging between 0.1 and 30.0 microns with a D50 value of between 1.0 and 20.0 microns. In those embodiments where the first cathode layer 302 has a single-modal particle size distribution, the second cathode layer 304 has a single-modal particle size distribution with particles having a diameter ranging between 0.01 and 200.0 microns with a D50 value of between 0.05 and 100.0 microns, with the exception that the distribution (diameter and/or D50 value) is different than that of the first cathode layer 302. For example, if the first cathode layer 302 has a single-modal particle size distribution with particles having a diameter ranging between 2.0 and 15.0 microns with a D50 value of between 5.0 and 10.0 microns, the second cathode layer 304 can have a single-modal particle size distribution with particles having a diameter ranging between 0.01 and 1.9 and 15.1 and 200.0 microns with a D50 value of between 0.05 and 4.9 and 10.1 and 100.0 microns. For example, in embodiments where the second particle size distribution is smaller than the first particle size distribution, the second cathode layer 304 can have a single-modal particle size distribution with particles having a diameter ranging between 0.01 and 1.9 microns with a D50 value of between 0.05 and 4.9 microns. Other combinations are possible, and all such configurations are within the contemplated scope of this disclosure.

In another example, in embodiments having differing chemical makeup, the first cathode layer 302 is made of a material having a first chemical makeup and the second cathode layer 304 is made of a material having a second chemical makeup different than the first chemical makeup. In some embodiments, the first cathode layer 302 is made of a material having a layered oxide structure (e.g., NCMA, NMC, NCA, etc.), a spinel oxide structure (e.g., LMO, LNMO, etc.), a two-phase structure (e.g., monoclinic and/or layered LMR, etc.), and/or a non-olivine type structure. Conversely, in some embodiments, the second cathode layer 304 is made of a material having an olivine structure (e.g., LFP, LMFP, etc.).

In some embodiments, the physical thickness of the deposited layers of the first cathode layer 302 and the second cathode layer 304 are varied to target a predetermined final dual-chemistry composite structure. For example, in some embodiments, the first cathode layer 302 is deposited to a first thickness (denoted H₁ in FIG. 3) and the second cathode layer 304 is deposited to a second thickness (denoted H₂ in FIG. 3) different than the first thickness. In some embodiments, the respective thicknesses are set to achieve a predetermined weight distribution between the layers. For example, in some embodiments, the weight ratio of the first cathode layer 302 to the second cathode layer 304 (top:bottom) is 10:90, 20:80, 30:70, 40:60, 50:50, 60:40, 70:30, 80:20, or 90:10 percent. Similarly, in some embodiments, the thickness ratio of the first cathode layer 302 to the second cathode layer 304 (top:bottom) is 10:90, 20:80, 30:70, 40:60, 50:50, 60:40, 70:30, 80:20, or 90:10 percent, with a total double-layer thickness ranging between 20.0 and 300.0 microns.

In some embodiments, the first cathode layer 302 and the second cathode layer 304 have differing chemical makeup (refer above) but the same active material loading. For example, in some embodiments, the first cathode layer 302 is an NMC/NCMA layer having an active material loading by weight of between 90 and 98 percent, with 2 to 8 percent binder (e.g., PVDF, etc.), and a carbon additive of between 0.1 and 5 percent, and the second cathode layer 304 is an LFP layer having an active material loading by weight of between 90 and 98 percent, with 2 to 8 percent binder (e.g., PVDF, etc.), and a carbon additive of between 0.1 and 5 percent. In another example, in some embodiments, the first cathode layer 302 is an LFP layer having an active material loading by weight of between 90 and 98 percent, with 2 to 8 percent binder (e.g., PVDF, etc.), and a carbon additive of between 0.1 and 5 percent, and the second cathode layer 304 is an NMC/NCMA layer having an active material loading by weight of between 90 and 98 percent, with 2 to 8 percent binder (e.g., PVDF, etc.), and a carbon additive of between 0.1 and 5 percent.

In some embodiments, the first cathode layer 302 and the second cathode layer 304 have differing chemical makeup (refer above) and different active material loadings. For example, in some embodiments, the first cathode layer 302 is an NMC layer having an active material loading by weight of more than 50 percent, and the second cathode layer 304 is an LFP layer having an active material loading by weight of less than 50 percent. In another example, in some embodiments, the first cathode layer 302 is an NMC layer having an active material loading by weight of less than 20 percent, and the second cathode layer 304 is an LFP layer having an active material loading by weight of more than 80 percent, or 90 percent, or 94 percent, or 97.5 percent.

Notably, in some embodiments, the active material loading of the second cathode layer 304 (the top layer) can be greater than 94 percent, even for LFP and LMFP chemistries. That is, in some embodiments, the second cathode layer 304 is an LFP or LMFP layer having an active material loading by weight of 94, 95, 96, 97, 97.5, 98, and 99 percent. In some embodiments, the second cathode layer 304 is an LFP or LMFP layer having an active material loading by weight of 97.5 percent.

In some embodiments, the first cathode layer 302 and the second cathode layer 304 are formed (e.g., rolled, pressed, etc.) to different porosities. Differing porosities can be created using co-calendaring or separate, targeted calendaring and both configurations are within the contemplated scope of this disclosure. For example, in embodiments using co-calendaring, the first cathode layer 302 and the second cathode layer 304 are calendared as the same time to a final, combined porosity of the double layer (that is, of the cathode active material layer 212) of between 20 and 40 percent.

Alternatively, in embodiments using separate calendaring, the first cathode layer 302 and the second cathode layer 304 can be calendared sequentially using different calendaring procedures according to the respective particle size distributions (refer above) for greater porosity control (so-called porosity-controlled coating). In some embodiments, the first cathode layer 302 is calendared prior to deposited/forming the second cathode layer 304. In some embodiments, the first cathode layer 302 and the second cathode layer 304 is then calendared again to create a porosity-gradient architecture within the cathode active material layer 212. In these embodiments, the first cathode layer 302 can have a first porosity of between 20 and 50 percent, and the second cathode layer 304 can have a second porosity of between 30 and 60 percent. In some embodiments, the second porosity is higher than the first porosity.

Notably, in some embodiments, the active material loading of the second cathode layer 304 (the top layer) can be greater than 94 percent, even for LFP and LMFP chemistries and, at the same time, the porosity of the second cathode layer 304 can be less than 60 percent, for example 20 to 40 percent. This is an observable advantage over prior electrodes, as relatively high active material concentrations (that is, concentrations greater than 94 percent) are unstable at porosities less than 60 percent in single-component electrodes due to delamination effects.

In some embodiments, the first cathode layer 302 and the second cathode layer 304 include different binders. For example, in some embodiments, the first cathode layer 302 includes one or more of PVDF, CMC, PVDF-Co-HFP, LiPAA, PAA, PVA, and PVP, and the second cathode layer 304 includes a different subset of those binders. In some embodiments, the first cathode layer 302 includes PVDF binder and the second cathode layer 304 includes CMC binder. In some embodiments, the first cathode layer 302 includes PVDF binder and the second cathode layer 304 includes PVDF-Co-HFP binder.

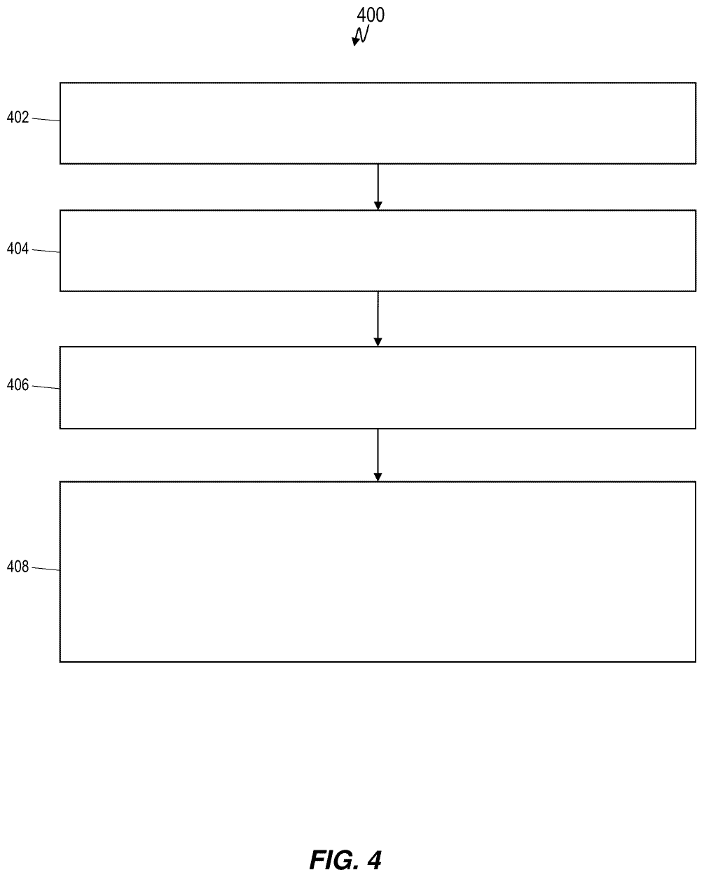

Referring now to FIG. 4, a flowchart 400 for manufacturing dual-chemistry electrodes is generally shown according to an embodiment. The flowchart 400 is described in reference to FIGS. 1-3 and may include additional steps not depicted in FIG. 4. Although depicted in a particular order, the blocks depicted in FIG. 4 can be rearranged, subdivided, and/or combined.

At block 402, the method includes providing an anode current collector.

At block 404, the method includes forming an anode active material layer in direct contact with a surface of the anode current collector.

At block 406, the method includes providing a cathode current collector.

At block 408, the method includes forming a cathode active material layer in direct contact with a surface of the cathode current collector. In some embodiments, the cathode active material layer includes a dual-chemistry electrode having a first cathode layer in direct contact with the cathode current collector and a second cathode layer positioned directly on the first cathode layer. In some embodiments, the first cathode layer and the second cathode layer include materials having at least one of a different particle size distribution and a different chemical makeup.

In some embodiments, the first cathode layer includes a material having a first particle size distribution and the second cathode layer includes a material having a second particle size distribution different than the first particle size distribution.

In some embodiments, the second particle size distribution is smaller than the first particle size distribution.

In some embodiments, the first cathode layer includes a bi-modal particle size distribution with a first set of particles having a diameter ranging between 0.1 and 7.0 microns with a D50 value of between 1.0 and 5.0 microns and a second set of particles having a diameter ranging between 5.0 and 30.0 microns with a D50 value of between 5.0 and 15.0 microns. In some embodiments, the second cathode layer includes a single-modal particle size distribution with particles having a diameter ranging between 0.01 and 200.0 microns with a D50 value of between 0.05 and 100.0 microns.

In some embodiments, the first cathode layer includes at least one of a layered oxide structure, a spinel oxide structure, a two-phase structure, and a non-olivine type structure and the second cathode layer includes an olivine structure.

In some embodiments, the first cathode layer includes at least one of NCMA, NMC, NCA, LMO, LNMO, LMR and the second cathode layer includes at least one of LFP and LMFP. In some embodiments, the first cathode layer includes NMC and the second cathode layer includes LFP.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising a battery cell, the battery cell comprising:
an anode current collector;
an anode active material layer in direct contact with a surface of the anode current collector;
a cathode current collector; and
a cathode active material layer in direct contact with a surface of the cathode current collector, the cathode active material layer comprising a dual-chemistry electrode having a first cathode layer in direct contact with the cathode current collector and a second cathode layer positioned directly on the first cathode layer;
wherein the first cathode layer and the second cathode layer comprise at least one of a different particle size distribution and a different chemical makeup.

2. The vehicle of claim 1, wherein the first cathode layer comprises a material having a first particle size distribution and the second cathode layer comprises a material having a second particle size distribution different than the first particle size distribution.

3. The vehicle of claim 2, wherein the second particle size distribution is smaller than the first particle size distribution.

4. The vehicle of claim 1, wherein the first cathode layer comprises a bi-modal particle size distribution with a first set of particles having a diameter ranging between 0.1 and 7.0 microns with a D50 value of between 1.0 and 5.0 microns and a second set of particles having a diameter ranging between 5.0 and 30.0 microns with a D50 value of between 5.0 and 15.0 microns; and
wherein the second cathode layer comprises a single-modal particle size distribution with particles having a diameter ranging between 0.01 and 200.0 microns with a D50 value of between 0.05 and 100.0 microns.

5. The vehicle of claim 1, wherein the first cathode layer comprises at least one of a layered oxide structure, a spinel oxide structure, a two-phase structure, and a non-olivine type structure and the second cathode layer comprises an olivine structure.

6. The vehicle of claim 5, wherein the first cathode layer comprises at least one of nickel cobalt manganese aluminum oxide (NCMA), nickel manganese cobalt oxide (NMC), nickel cobalt aluminum oxide (NCA), lithium manganese oxide (LMO), lithium nickel manganese oxide (LNMO), lithium manganese rich (LMR) and the second cathode layer comprises at least one of lithium iron phosphate (LFP) and lithium manganese iron phosphate (LMFP).

7. The vehicle of claim 6, wherein the first cathode layer comprises NMC and the second cathode layer comprises LFP.

8. A battery cell comprising:
an anode current collector;
an anode active material layer in direct contact with a surface of the anode current collector;
a cathode current collector; and
a cathode active material layer in direct contact with a surface of the cathode current collector, the cathode active material layer comprising a dual-chemistry electrode having a first cathode layer in direct contact with the cathode current collector and a second cathode layer positioned directly on the first cathode layer;
wherein the first cathode layer and the second cathode layer comprise at least one of a different particle size distribution and a different chemical makeup.

9. The battery cell of claim 8, wherein the first cathode layer comprises a material having a first particle size distribution and the second cathode layer comprises a material having a second particle size distribution different than the first particle size distribution.

10. The battery cell of claim 9, wherein the second particle size distribution is smaller than the first particle size distribution.

11. The battery cell of claim 8, wherein the first cathode layer comprises a bi-modal particle size distribution with a first set of particles having a diameter ranging between 0.1 and 7.0 microns with a D50 value of between 1.0 and 5.0 microns and a second set of particles having a diameter ranging between 5.0 and 30.0 microns with a D50 value of between 5.0 and 15.0 microns; and
wherein the second cathode layer comprises a single-modal particle size distribution with particles having a diameter ranging between 0.01 and 200.0 microns with a D50 value of between 0.05 and 100.0 microns.

12. The battery cell of claim 8, wherein the first cathode layer comprises at least one of a layered oxide structure, a spinel oxide structure, a two-phase structure, and a non-olivine type structure and the second cathode layer comprises an olivine structure.

13. The battery cell of claim 12, wherein the first cathode layer comprises at least one of nickel cobalt manganese aluminum oxide (NCMA), nickel manganese cobalt oxide (NMC), nickel cobalt aluminum oxide (NCA), lithium manganese oxide (LMO), lithium nickel manganese oxide (LNMO), lithium manganese rich (LMR) and the second cathode layer comprises at least one of lithium iron phosphate (LFP) and lithium manganese iron phosphate (LMFP).

14. The battery cell of claim 13, wherein the first cathode layer comprises NMC and the second cathode layer comprises LFP.

15. A method comprising:
providing an anode current collector;
forming an anode active material layer in direct contact with a surface of the anode current collector;
providing a cathode current collector; and
forming a cathode active material layer in direct contact with a surface of the cathode current collector, the cathode active material layer comprising a dual-chemistry electrode having a first cathode layer in direct contact with the cathode current collector and a second cathode layer positioned directly on the first cathode layer;
wherein the first cathode layer and the second cathode layer comprise at least one of a different particle size distribution and a different chemical makeup.

16. The method of claim 15, wherein the first cathode layer comprises a material having a first particle size distribution and the second cathode layer comprises a material having a second particle size distribution different than the first particle size distribution.

17. The method of claim 16, wherein the second particle size distribution is smaller than the first particle size distribution.

18. The method of claim 15, wherein the first cathode layer comprises a bi-modal particle size distribution with a first set of particles having a diameter ranging between 0.1 and 7.0 microns with a D50 value of between 1.0 and 5.0 microns and a second set of particles having a diameter ranging between 5.0 and 30.0 microns with a D50 value of between 5.0 and 15.0 microns; and
wherein the second cathode layer comprises a single-modal particle size distribution with particles having a diameter ranging between 0.01 and 200.0 microns with a D50 value of between 0.05 and 100.0 microns.

19. The method of claim 15, wherein the first cathode layer comprises at least one of a layered oxide structure, a spinel oxide structure, a two-phase structure, and a non-olivine type structure and the second cathode layer comprises an olivine structure.

20. The method of claim 19, wherein the first cathode layer comprises at least one of nickel cobalt manganese aluminum oxide (NCMA), nickel manganese cobalt oxide (NMC), nickel cobalt aluminum oxide (NCA), lithium manganese oxide (LMO), lithium nickel manganese oxide (LNMO), lithium manganese rich (LMR) and the second cathode layer comprises at least one of lithium iron phosphate (LFP) and lithium manganese iron phosphate (LMFP).
